(19) United States
(12) Patent Application Publication
(10) Pub. No.: US 2006/0045019 A1
(43) Pub. Date: Mar. 2, 2006

(54) Network testing agent with integrated microkernel operating system

(76) Inventors: Till Immanuel Patzschke, Wiesbaden (DE); Darren Leroy Wesemann, North Salt Lake, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/216,971

(22) Filed: Aug. 31, 2005

Related U.S. Application Data
(60) Provisional application No. 60/606,875, filed on Sep. 1, 2004.

(51) Int. Cl. H04L 12/26

(52) U.S. Cl. 370/241

(57) ABSTRACT

A system for performing testing of a network device includes an agent. The agent can simulate multiple simultaneous users that access the network device or test the service provided to individual users. The agent generally includes: a plurality of microprocesses, each corresponding to a simulated user and including data packet templates; agent code configured to switch between the plurality of microprocesses to enable the microprocesses to create data packets from the data packet templates and to initiate the transmission of the data packets in response to the state of the corresponding simulated user; and a microkernel configured to preformat the data packets prior to transmitting the data packets to an operating system associated with the agent. The agent can also be used to determine quality of service ratings.

### CROSS-REFERENCE TO RELATED APPLICATIONS

This application claims the benefit of U.S. Provisional Patent Application No. 60/606,875, filed Sep. 1, 2004, which is incorporated herein by reference in its entirety.

### BACKGROUND OF THE INVENTION

1. The Field of the Invention

The present invention relates to communications networks. More particularly, the present invention is directed to systems and methods for using an integrated agent and an integrated microkernel operating system to make load testing in networks more efficient and scalable.

2. The Relevant Technology

Consumers today often have access to many services through various types of networks. Cable networks, satellite networks, cellular networks, and computer networks such as the Internet are examples of networks through which various types of services are provided. The services available through these types of networks are often provided to thousands or millions of consumers. When a user purchases a service from a service provider, the service provider has an interest in insuring that the user receives an accessible and quality product.

One way to provide an accessible and quality product is to perform testing to ensure that servers or other equipment can serve a substantial number of users without crashing or otherwise failing. This type of testing is often referred to as load testing and is typically performed using simulations in a laboratory environment. By way of example, U.S. patent application Ser. No. 10/049,867, incorporated herein by reference, discloses systems and methods for load testing of networks and network components. A laboratory environment permits a service provider to enact various scenarios to determine whether a particular service can be delivered over a network. A load balancing test, for example, helps determine how well the servers can withstand a large number of requests. This type of test is not usually performed in a live network because of the possibility of crashing a network or failing various connectivity components. It is one thing to crash a laboratory network and quite another to deprive customers of the services they have purchased.

A convenient way of performing load testing is to use a load testing agent that simulates the activity of multiple simultaneous users. Load testing can be as simple as packet blasting, which generates and transmits to a network a large number of data packets. Load testing can also be more dynamic by using agents that simulate the activity of multiple simultaneous users and the synchronous exchanges between clients and remote network devices. Such dynamic load testing requires the agent to monitor the state of each simulated client or user to generate data packets that correspond to activity that might be experienced in real-life conditions.

One important consideration for load testing is the need for scalability. In particular, since load testing might require simulating an arbitrarily large number of users, a suitable load testing device should preferably be capable of simulating the required number of users. Often, load testing involves the simulation of tens of thousands or more simultaneous users. When load testing is as large as this, the equipment needed to generate sufficient data packets and otherwise model the activity of all simulated users can be quite expensive. Thus, the limiting factor for large load tests has often been the expense of obtaining significant amounts of load testing hardware and software, which is often a general purpose computer having a load testing agent.

A typical load testing agent operates by initiating multiple instances of a simulated user. For example, if a conventional load testing agent is to simulate the activity of one thousand users, the load testing agent initializes one thousand processes or simulated user modules. In this situation, the operating system of the computer on which the agent operates switches among the multiple processes to permit the processes to generate and respond to network activity. Additionally the operating system needs to perform various tasks itself to allow the processes to actually send and receive packets over the computers network interface(s). The computer on which the agent operates could be a general purpose computer and uses a general purpose operating system, such as Windows or Linux, as well as a specialized computer hardware running a tailored general purpose operating system such as Linux.

The burden placed on operating systems in this manner represents the limiting factor for the ability to scale the number of users that can be simulated by conventional load testing agents. For example, as shown in FIG. 1, each process 10 representing a simulated user has an agent code 12, data 14 and a stack 16 and uses an API (not shown) for interfacing with the operating system 18 of the load testing device. The processes 10 thus are encoded to simulate an actual user. Furthermore, conventional load testing systems require the operating system 18 to form connections to a network server 20. As will be appreciated, when load testing is done for potentially thousands of simulated users, the operating system 18 switching between the large number of processes 10 and forming a large number of connections to a network requires significant computing resources, in some cases preclusively so. Accordingly, methods and systems for increasing load testing capabilities without overtaxing computing and network resources would represent a significant advance in the art.

### BRIEF SUMMARY OF THE INVENTION

The present invention relates to techniques for testing the services provided to users by a service provider. More particularly, the present invention relates to the use of agents in connectivity devices to test the relevant devices and systems. In one embodiment of the invention, the methods reduce the computational burden on the operating system of a connectivity device that operates a load testing agent. Because the computational burden on the operating system is reduced, load testing agents that operate according to the invention can simulate significantly more users than conventional load testing agents. In another embodiment of the invention, one or more connectivity devices are tested to determine the quality of services provided.

Accordingly, a first example embodiment of the invention is a system for performing load testing of a network device. The system includes an agent that simulates multiple simultaneous users that access the network device. The agent, in turn, includes: a plurality of microprocesses, each corresponding to a simulated user and including data packet templates; agent code configured to switch between the plurality of microprocesses to enable the microprocesses to create data packets from the data packet templates and to initiate the transmission of the data packets in response to the state of the corresponding simulated user; and a microkernel configured to preformat the data packets prior to transmitting the data packets to an operating system associated with the agent.

Another example embodiment of the invention is a method for transmitting out-of-band data packets. This method includes: initiating operation of an agent in a computing device, the agent having a microprocess and a microkernel; by the microkernel, receiving data packets from the microprocess and formatting the data packets with known source and destination address of a network recipient prior to sending the data packets to the network recipient; and sending the formatted data packet to the network recipient.

Yet another example embodiment of the invention is a method for estimating the quality of services received by a user from a network based service provider. The method includes: providing an agent on a connectivity device that is in at least intermittent communication with a network recipient; initiating, at a microprocess on the agent, an operation of the agent that tests the operation of the connectivity device; by a microkernel on the agent, receiving at least one data packet from the microprocess and formatting the data packet with known source and destination address of a network recipient prior to sending the data packet to the network recipient; and sending the formatted data packet to the network recipient. The network recipient receives the data packet and uses the data packet to determine a rating that is predictive of at least one aspect of the quality of services experienced by a user in normal operation of the connectivity device.

These and other objects and features of the present invention will become more fully apparent from the following description and appended claims, or may be learned by the practice of the invention as set forth hereinafter.

### BRIEF DESCRIPTION OF THE DRAWINGS

To further clarify the advantages and features of the present invention, a description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a conventional system used for load testing;

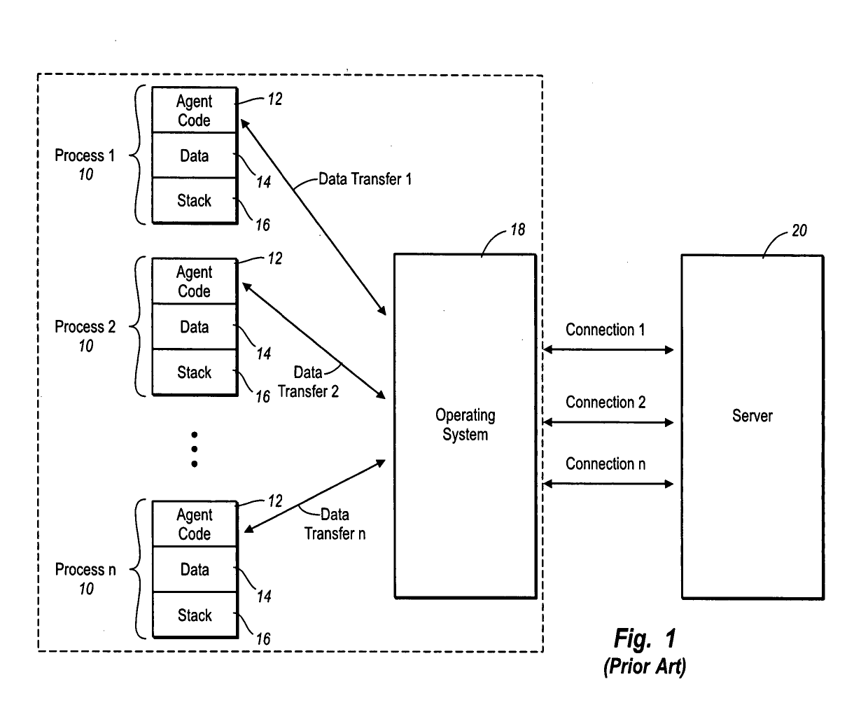

FIG. 2 illustrates a system for load testing a network device or testing a connectivity device according to an example embodiment of the invention; and

FIG. 3 illustrates a system for load testing a network device or testing a connectivity device according to another example embodiment of the invention.

### DETAILED DESCRIPTION OF THE PREFERRED EMBODIMENTS

In the following description, numerous specific details are set forth in order to provide a thorough understanding of the present invention. It will be obvious, however, to one skilled in the art that the present invention may be practiced without these specific details. In other instances, well-known aspects of networks, service providers, protocols, and the like have not been described in particular detail in order to avoid unnecessarily obscuring the present invention. In addition, it is understood that the drawings are diagrammatic and schematic representations of presently preferred embodiments of the invention, and are not limiting of the present invention nor are they necessarily drawn to scale.

The present invention relates to techniques for testing the services provided to users by a service provider. In one embodiment of the invention, the methods reduce the computational burden on the operating system of a connectivity device that operates a load testing agent. Because the computational burden on the operating system is reduced, load testing agents that operate according to the invention can simulate significantly more users than conventional load testing agents. In another embodiment of the invention one or more connectivity devices are tested to determine the quality of services provided. The testing can be done on any type of connectivity device, for example, a set top box, a cable modem, a telephone, a cellular telephone, a personal digital assistant, a computer, other connectivity devices, and the like or any combination thereof. Testing can be done within a laboratory setting or across a network such as the Internet.

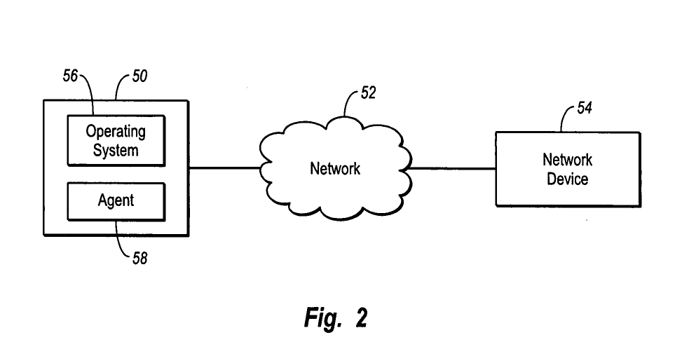

Accordingly, FIG. 2 illustrates various exemplary environments in which the invention can be practiced. In FIG. 2, a connectivity device 50 is illustrated. The connectivity device can be a desktop or laptop computer or can represent a more use-specific connectivity device such as, for example, a set-top box, a cable modem, a telephone, a cellular telephone, a personal digital assistant, other connectivity devices, and the like or any combination thereof. The connectivity device includes, among other things, an operating system 56 and an agent 58. The agent in each device can be configured to measure and/or monitor a user experience by, for example: load testing, testing network connectivity and access to an ISP; testing the quality of services delivered to end users; monitoring service level agreements for bandwidth-on-demand; and monitoring network access to content servers, application servers, etc.

The depicted connectivity device 50 is in communication with a network device 54 via a network 52. The network device 54 can be a device used by a service provider to provide a service to connectivity device 50 or can be a device used more specifically for directing and evaluating testing in a controlled environment. The network 52 represents various types of connections that connect connectivity device 50 to network device 54, examples of which include, but are not limited to: a direct connection, cellular, dial-up, DSL, ISDN, broadband networks, fiber optic networks, and the like or any combination thereof.

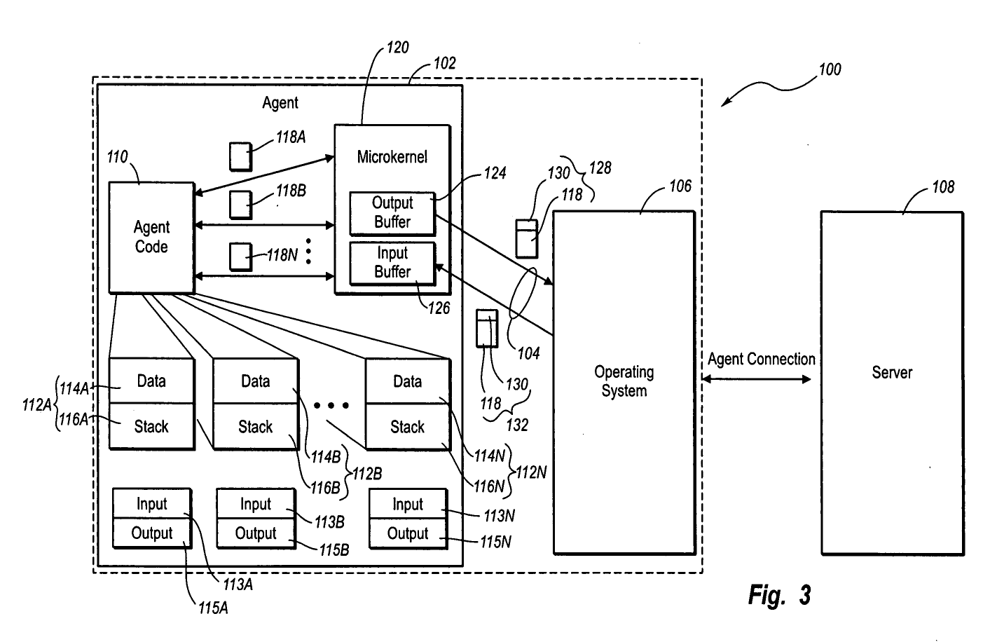

With reference to FIG. 3, an exemplary system 100 for load testing is illustrated. In this embodiment, an agent 102 and an operating system 106 preferably reside on the same connectivity device, as indicated by the dotted line encompassing both. The agent 102 initiates and executes a single process (or small number of processes). Thus, the operating system 106 handles only a single process 104 (or a small number of processes), which minimizes the process switching compared to that which has been required in connection with conventional load testing agents. As will be clear from the following discussion, because the number of processes 104 that the operating system 106 is required to handle is minimal, the processing requirements of the operating system 106 is small, making the present invention extremely efficient and scalable. The agents of the present invention can be defined to operate in a restricted environment in terms of the computational and data storage resources that are available to the agent. For example, agents of the present invention can be embedded on a device, such as a special-purpose monitoring and testing system. Of course, agents of the present invention may also be implemented in operating systems in which the agent has access to other computational and data storage resources, such as a general-purpose computer. Thus, while embodiments of the invention may be shown as having an agent external of an operating system, it will be understood that the agent may actually reside on the operating system and communicate therewith.

With further reference to FIG. 3, the agent 102 includes a single block of agent code 110 that switches between multiple instances 112A through 112N of “microprocesses.” The microprocesses 112A through 112N include the corresponding data 114A through 114N and stacks 116A through 116N. As such, each microprocess 112A through 112N represents a single simulated user, such that the N microprocesses can simulate an arbitrary number of users. The agent code 110, rather than the operating system 106, is responsible for switching between the microprocesses 112A through 112N. Switching between simulated users in this manner is more efficient than switching among processes by the operating system 106.

Each of the data 114A-N represents a different simulated user. The microprocesses 112A-N simulate the load generated by the users in a way that tracks the state of the users and responds to incoming data packets from the device under test in an intelligent way. The agent code 110 and the data 114A-N are used to monitor or track the state of each simulated user so that the network traffic that is generated is similar to that which might be expected in actual deployed networks.

As used herein, the terms “microprocess” and “instance” are used interchangeably to represent the simulation of a user. Each microprocess 112A through 112N forms instances that can send and receive data over the network. Each microprocess 112A through 112N contains preformatted input data packets 113A and preformatted output data packets 115A. The input data packets 113A and output data packets 115A are essentially data packet templates that contain preformatted protocol and header information to direct agent code 110 how to handle instance data packets 118A through 118N being transmitted or received from the operating system 106. For example, agent code 110 uses the preformatted data in the output data packet 115A to create an instance data packet 118A including data reflecting the state of the simulated user “A” as well as other protocol and/or address information to direct the data packet to an intended destination. Similarly, the agent code 110 could check protocol and header information contained in an incoming instance data packet 118A through 118N and reference information contained in the input data packets 113A through 113N to determine where to return the information carried on the instance data packet.

In other words, instance data packets 118A through 118N can be formatted using some static information and some variable information. That static information, as mentioned above, is the preformatted information containing known information that is applicable to all outgoing and incoming instance data packets 118A through 118N that are generated or received during a load test. This static information can include, but is not limited to, protocol and header information, and is generally identified using the input data packets 113A through 113N and output data packets 115A through 115N. The variable information varies between the microprocesses 112A through 112N and varies as successive data packets are generated and received by individual microprocesses 112A through 112N during a load test. The variable information of outgoing data packets is generated using the data 114 for each microprocess, based on the state of the microprocess and the nature of the communication with the network device that is being tested. Because much of the information contained in the data packets is static, the computational requirements of the system are reduced by dynamically generating only the information that varies from data packet to data packet.

As shown in FIG. 3, the agent 102 also includes a microkernel 120 which performs additional functions to reduce the computational requirements of operating system 106. One drawback of conventional load testing systems is the fact that the operating system needs to manage the network connections for all N simulated users. As will now be discussed, the microkernel 120 significantly reduces this burden on the operating system 106 of forming network connections and managing a transmission of the data between the microprocesses 112A through 112N and the network device 108, for example a server, that is to be subjected to a load test.

In one embodiment, the instance data packets 118A through 118N are further manipulated by the agent 102 to increase the efficiency of the load testing process. When the microprocess 112 associated with a particular simulated user requires the creation and transmission of an output data packet, the corresponding output data packet is sent to the microkernel 120. As shown in FIG. 3, the microkernel 120 includes an output buffer 124 and an input buffer 126. The output buffer 124 stores instance data packets 118A through 118N and transmits them to the operating system 106.

Before storage in the output buffer 124 or subsequent thereto, the microkernel 120 places preformatted information on each instance data packet to form a formatted data packet 128. While only one formatted data packet 128 is shown, it will be appreciated that microkernel 120 formats each outgoing instance data packet 118 before transmission to the operating system 106. Exemplarily, formatted data packet 128 includes a formatted portion 130 along with the particular instance data packet 118. The formatted portion 130 can include the IP address and IP port of that instance, as well as the IP address and IP port of the formatted data packet destination, as well as Ethernet source and destination addresses, packet types and the like. Thus, the data packets transmitted from the microkernel 120 are herein referred to as formatted data packets 128.

The microkernel 120 then sends the formatted data packet 128 to the operating system 106 which, in turn, sends the formatted data packet to the network device 108 or any other network device that is involved in the load test. By doing so, the internal packet handling routines of operating system 106 are bypassed, reducing the operating systems functionality to a simple forwarding operation. The microkernel 120 also receives return data packets 132 from the network connection, and can extract data and pass it to the agent code 110. The microkernel 120 may additionally perform checksums or other operations on the incoming data packets 132. Although the operation system 106 receives incoming data packets 132, the incoming data packets are forwarded to the microkernel 120 unprocessed, further reducing the burden on operating system 106.

The function of microkernel 120 is possible without unduly overburdening the computational resources of the microkernel because it is based on the observation that, in a network load test, the nature of the instance data packets 118A through 118N (e.g., the protocols and addresses) that are to be generated and received can be known prior to the test. As discussed above with respect to agent 110 using static information and variable information to create instance data packets 118, in a similar manner, microkernel 120 uses some static information and some variable information to create connection portion 130 of formatted data packet 128. Static information can include information such as, but not limited to, TCP header ports, IP header addresses, and Ethernet headers, while variable information can include things such as, but not limited to, checksums and sequence numbers. The efficiency of the present invention results from reducing the packet creation task to being only concerned with inserting variable information while keeping all of the static information stored in the microkernel 120. Because the static information can be known, preformatting in this manner enhances the efficiency of the process while maintain high accuracy of connection information. As such, microkernel 120 reduces the computational requirements of this process significantly. For this reason, the instance data packets 118A through 118N can be easily generated and handled, as well as formatted data packets 128. Moreover, the function of switching between multiple processes 112A through 112N is relegated to the agent code 110, thus significantly reducing the computational requirements of the operating system 106.

The ability of the microkernel to place formatted connection information 130 onto the outgoing instance data packet 118 to form a formatted data packet 128 further acts to reduce the computation resources required from the operation system 106. In this manner, the operating system 106 does not need to initiate and manage connections for each of the instances, but instead simply receives formatted data packets 128 from the microkernel 120 that can then be transmitted to the network. The complexity of the creation, processing, and formatting of the data packets is essentially hidden from the operating system 106. As mentioned above, because much of the header and connection information can be known in advance, data packets 128 can be preformatted, reducing the processing to simply inserting variable information into the connection information 130 of the formatted data packet 128.

The microkernel 120 makes load testing more efficient and highly scalable. As the agent code 110 switches among the multiple instances or microprocesses 112A through 112N, microkernel 120 acts as an intermediary and permits the operating system 106 to handle as few as one network connection that is used to send and receive preformatted packets for all microprocess instances 112A through 112N, reducing the operating system's 106 function to handling the network device only.

In one embodiment, a single laptop computer can simulate tens of thousands or more simultaneous users in a load test. Thus, when a network administrator or a developer is to perform a large load test, the availability of hardware is no longer a significant concern. Furthermore, the processing power of the operating system 106 is also not as important as in conventional load testing processes. The present invention thus greatly reduces the cost of performing such large load test.

The load testing agents described in U.S. patent application Ser. No. 11/176,838, filed Jul. 7, 2005, which is incorporated by reference herein in its entirety, can be adapted to operate in the manner described herein.

Various additional embodiments of the present invention are contemplated. For example, agent 102 may be configured in a variety of ways which can reduce the number of processes 104 that communicate with operating system 106. For example, agent 102 may be encoded to have multiple agent code modules 110, each of which handles multiple microprocesses 112A through 112N. In this embodiment, the operating system switches between a relatively small number of processes and handles a relatively small number of network connections. In any case, the number of processes and connections is generally very small compared to the number of simulated users and the number of processes that would be required in conventional load testing systems.

In another embodiment, rather than establishing a network connection, the microkernel may provide access to a network interface, a hard drive or other components of a computer. The agent 102 may be used to send and receive out of band packets. In this embodiment, an agent 102 initiates a single process on a standard operating system. The microkernel 120 formats the instance data packet and sends the instance data packet out of band. The microkernel 120 then monitors all incoming packets for those dedicated to the agent 102.

In still another embodiment, the agent 102 would function substantially as described above, but would have direct access to the hardware of a computer. In this way, the agent 102 could function independent of the main operating system of the computer. These techniques could be used by governmental agencies or other entities that are authorized to monitor communication or computer usage of third parties, and permit such agencies from doing so in a way that is substantially incapable of being detected by the user.

As previously mentioned, the testing performed by agent 102 may include methods for testing the services provided to an end-user. Testing the services provided to an end user can include, but is not limited to: proactive measurement of a user's experience across a network by accurately replicating real user activities, monitoring the services provided to the end user, measuring various metrics or parameters related to the connectivity device of the end user, and the like. Advantageously, embodiments of the present invention occur from the perspective of the end user using an agent that is embedded in the device of the end user. The agent provides visibility into the accuracy of the user's experience and can accurately measure the services provided the end user.

For example, embodiments of the inventions can detect customer experience issues by proactively consuming and measuring the end-to-end performance of services provided by a service provider before the user does, raising an alarm when service thresholds have been exceeded or service quality is low. By embedding a testing agent within a user's actual connectivity device, the systems and methods of the invention allow for an accurate understanding of a connectivity device's actual performance for a user. By performing the tests when the connectivity device is not in use by a user, the tests avoid slowing the user's actual experience. Embodiments can also provide tools to understand how real users interact with a service provider's network. In addition, the systems and methods of the invention are scalable and extensible in that they can gather, store, and learn from literally millions of agents installed on connectivity devices.

Embodiments of the invention can therefore monitor, test and/or measure the services or connections of multiple devices. The agents embedded in the devices of the end users can generate data or network activity that closely mirrors actual user experiences or data or network activity that monitors an actual user experience. Agents are deployed in each device and each agent may perform tests that at least copy the actions of end users. To accurately measure the service provided to an end user, the tests may be related to a service level agreement of the user. Agents are not limited, however, to performing tests or taking measurements that are related to an end user's service level agreement, but can also perform other tests or measurements. One benefit of configuring an agent to perform actions that correspond with a particular service level agreement is that the agent can provide data that can be used to evaluate the quality of the services delivered to the end user.

More specifically, an agent embedded in a user's device enables service providers to ensure the quality of the services received through the user devices. Testing a service from the perspective of an end user provides data that may enable the problem to be resolved more quickly. When a user purchases a service and is not receiving that service, for example, the user may only recognize that the service is unavailable or is of poor quality. The user is not necessarily interested in why the service failed or is of poor quality. The user is also not typically aware of nor cares where the problem is occurring. As previously mentioned, monitoring the user's connection at a location remote from the user does not accurately reflect the user's experience and may make it more difficult to identify the problem with the user's service. Embodiments of the invention, however, proactively measure the performance or quality of a service from the user's perspective and provide a service context from the end user's perspective.

When the agents embedded in the connectivity devices are adapted to the service level agreement of the end user, the agent can simulate user activity to measure the quality or performance of the service(s) being provided to the end user, including voice over IP, bandwidth-on-demand, video-on-demand, video conferencing, and the like. The agent can also measure or gauge the network connectivity and/or access to an ISP. The data collected by the agent reflects the experience of a real end user because the tests or measurements are being performed from the connectivity device of the end user.

Examples of protocols that can be tested for the different types of services and networks include access protocols such as: ATM (Asynchronous Transfer Mode), PPoEoA (Point-to-Point Protocol over Ethernet over ATM), PPPoA (Point-to-Point Protocol over ATM), PPPoE (Point-to-Point Protocol over Ethernet), PPPoEoA (Point-to-Point Protocol over Ethernet Over ATM), 1×RTT, and GPRS; network protocols such as: DHCP (Dynamic Host Configuration Protocol) and IP; application protocols such as HTTP (HyperText Transport Protocol), FTP (File Transfer Protocol), SMTP (Simple Mail Transfer Protocol), POP3 (Post Office Protocol 3), Logon/Logoff, Ping, RTSP (Real Time Streaming Protocol), Telnet, and NNTP (Network News Transfer Protocol).

In addition, the testing agent can be configured to perform tests on the connectivity device itself or on user applications that are run by the connectivity device but not controlled by a service provider. This allows a service provider to understand the quality of performance provided by applications and devices that may be outside its control. For example the performance of an email program, device operating system, or web browser can be tested to determine how well it is performing at various tasks.

The raw test information obtained from individual tests is collected at each agent and used to generate more useful data that predicts a user's quality of experience and help a service provider troubleshoot. By way of example only, examples of test data that can be determined from tests for the HTTP protocol include: start time for the HTTP request, the total time for a response after an HTTP request, header retrieval time, content retrieval time, error breakdown, and other metrics known in the art or readily apparent to those skilled in the art in view of the disclosure herein that are indicative of the quality and length of a task over a network. Similarly, test data can be determined for other protocols under test. For the POP protocol, example tests can include log in time, round trip delay to send a request and get a response, and time to delay a file of a given size.

In another aspect of the invention, load testing can enable a system to generate a rating indicative of the quality of a user's experience. This rating can be more easily used than raw data by an administrator to troubleshoot problems or identify successes and find efficient ways to improve. By way of example, this quality of experience score can be based on a 0-100 rating with 0 indicating a complete failure of a test and 100 indicating a perfect performance of the device and/or system under test. A score of 50 can be defined as an average performance. The ratings can be correlated to address various aspects of a connectivity device, selected services, or the system as a whole. As such, quality of experience scores can be determined, again by way of examples only, for: the performance of a set of cellular devices in a defined geographic range, the speed of Internet connections on connectivity devices, and the speed and reliability of electronic mail services on connectivity devices.

In various embodiments of the invention, the quality of experience scores can be determined by expert engines on a connectivity device, a host server, other servers or systems, or any combination of the above. An expert engine is generally a computer module that performs predictive analysis tasks. Typically, expert engines are used to analyze data in view of rules and other customizations to determine high level metrics such as ratings, scoring, predictive analysis, and other output to provide the predictive analysis. The predictive analysis allows an administrator to identify the level of a user's likely service satisfaction or quality of experience and to identify any problems and their likely sources. The output from the expert engine can then be used predict and prevent sources of problems for the end users and improve customer satisfaction. For example, the expert engine can be configured to provide an overall quality of experience score that a non-technical person could review. Such a score can be used to understand the quality of services provided to a user with a particular device at a particular location. A quality of experience score could also be used in an automated process to render alerts or provide recommendations for system upgrades in certain areas or advertise additional services to a user.

Embodiments of the invention enable the agents to report or collect the data resulting from the various tests or measurements. The transmission of reporting data can preferably be performed using the HTTP protocol that is typically used for the Internet. By formatting the reporting data in the HTTP protocol, the data can be sent through currently existing communication routes in an effective manner. For example, virtual private networks (VPNs) may work with a proxy at the center of an enterprise core that prevents the transmission of many types of data packets. Because HTTP is ubiquitous, packets formatted as web pages in HTTP are more easily recognized by network systems and routed to the intended destination.

The transmission of the data can also be performed, in one embodiment, using a messaging protocol such as SMTP (email). SMTP is scalable and can handle a large amount of data. In fact, transmitting data from multiple agents deployed on connectivity devices using SMTP takes advantage of the capabilities of existing networks and therefore reduces the likelihood of causing a failure in the network. Embodiments of the invention are not limited to SMTP, however, but can communicate using other protocols as well. The transmission may also depend on the type of device in which the agent is resident. For example, if the agent is a cellular telephone, then SMS, GPRS, or other scalable protocols may be used to transmit the data. In other words, existing networks have demonstrated the ability to handle a large number of transmissions using SMTP without problems. The agents described herein can therefore report results using SMTP. This enables a large number of deployed agents to transmit data that represents the experiences of a large number of end users. The data from the agents can be received by a server (or a server system) and stored in a database. The messages can also be parsed and processed before being stored.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for performing load testing of a network device, comprising:
an agent that simulates multiple simultaneous users that access the network device, the agent including:
a plurality of microprocesses, each corresponding to a simulated user and including data packet templates;
agent code configured to switch between the plurality of microprocesses to enable the microprocesses to create data packets from the data packet templates and to initiate the transmission of the data packets in response to the state of the corresponding simulated user; and
a microkernel configured to preformat the data packets prior to transmitting the data packets to an operating system associated with the agent.

2. A system as defined in claim 1, wherein the microkernel preformats the data packets by adding a known source and destination address of the network device such that the operating system can send data packets originating from multiple different microprocesses using only a single network connection, without processing individual packets.

3. A system as defined in claim 1, wherein the microkernel preformats the data packets in HTTP protocol.

4. A system as defined in claim 1, wherein the microkernel preformats the data packets in SMTP protocol.

5. A system as defined in claim 1, wherein the operating system handles a number of processes that is less than the number of simulated simultaneous users.

6. A system as defined in claim 1, wherein the operating system handles only one process while transmitting data packets for the multiple simulated simultaneous users.

7. A system as defined in claim 1, wherein the data packets that are transmitted to the network device include data that is generated in response to incoming data packets received from the network device.

8. A system as defined in claim 7, wherein at least one microprocess is initiated based on data received from the network device or events derived thereof.

9. A method for performing load testing of a network device, comprising using a system as defined in claim 1 to generate data packets that are transmitted to the network device.

10. A method for transmitting out-of-band data packets, comprising:
initiating operation of an agent in a computing device, the agent having a microprocess and a microkernel;
by the microkernel, receiving data packets from the microprocess and formatting the data packets with known source and destination address of a network recipient prior to sending the data packets to the network recipient; and
sending the formatted data packet to the network recipient.

11. A method as defined in claim 10, wherein sending the formatted data packet bypasses an operating system upon which the agent resides.

12. A method as defined in claim 10, further comprising sending the formatted data packet directly to the network recipient without passing the formatted data packet through any other operating system or network server.

13. A method as defined in claim 10, wherein the data packet is sent from the agent to the network recipient in HTTP protocol.

14. A method as defined in claim 10, wherein the data packet is sent from the agent to the network recipient as an SMTP packet.

15. A method for estimating the quality of services received by a user from a network based service provider, the method comprising:
providing an agent on a connectivity device that is in at least intermittent communication with a network recipient;
initiating, at a microprocess on the agent, an operation of the agent that tests the operation of the connectivity device;
by a microkernel on the agent, receiving at least one data packet from the microprocess and formatting the data packet with known source and destination address of a network recipient prior to sending the data packet to the network recipient; and
sending the formatted data packet to the network recipient;
wherein the network recipient receives the data packet and uses the data packet to determine a rating that is predictive of at least one aspect of the quality of services experienced by a user in normal operation of the connectivity device.

16. A method as defined in claim 15, wherein the connectivity device comprises a cellular telephone, a set-top box, a modem, a VoIP phone, a wirelessly connected computer, or a computer.

17. A method as defined in claim 15, wherein the network recipient further comprises an expert engine configured for analyzing the data packet and providing a predictive analysis.

18. A method as defined in claim 15, further comprising, at the network recipient, an act of processing the data packet and at least one additional data packet with an expert engine to determine the rating.

19. A method as defined in claim 15, wherein the data packets are sent from the agent to the network recipient in HTTP protocol.

20. A method as defined in claim 15, wherein the data packets are sent from the agent to the network recipient as an SMTP packet.

21. A method as defined in claim 15, wherein the operation of the agent comprises simulating an operation of a user operating the connectivity device.
